(19) United States
(12) Patent Application Publication
(10) Pub. No.: US 2026/0210794 A1
(43) Pub. Date: Jul. 23, 2026

(54) MONITORING THE CREEP OF AN AIRCRAFT TURBOMACHINE VANE

(71) Applicant: SAFRAN AIRCRAFT ENGINES, Paris (FR)

(72) Inventors: Jean-Philippe Bruno Pierre MALLAT-DESMORTIERS, Moissy-Cramayel (FR); Julia RENY, Moissy-Cramayel (FR); Jerome BROGERE, Moissy-Cramayel (FR); Olivier Jean-Daniel BAUMAS, Moissy-Cramayel (FR); Kevin TRAN VAN HOA DIT VINCENT, Moissy-Cramayel (FR)

(21) Appl. No.: 19/139,581

(22) PCT Filed: Dec. 11, 2023
(86) PCT No.: PCT/FR2023/051975

§ 371 Date: Jun. 16, 2025

(30) Foreign Application Priority Data
Dec. 16, 2022 (FR) 2213709

(51) Int. Cl. G01M 5/00

(52) U.S. Cl. CPC G01M 5/0016; G01M 5/0041

(57) ABSTRACT

Method for monitoring the creep of a turbomachine blade, in particular of an aircraft, the blade being made of a metal alloy and comprising at least one platform connected to at least one airfoil, the method comprising the following steps: a) determining at least one geometric monitoring parameter of the blade, this parameter having a value liable to evolve as a function of the deformations by creep of the blade, b) determining an acceptability threshold for the or each parameter, c) verifying in situ the conformity of the or each parameter with respect to the corresponding threshold, and d) concluding on the conformity of the blade as a function of the results of the verification.

### TECHNICAL FIELD OF THE INVENTION

The present invention relates to the general field of aeronautic. More specifically, it relates to a method for monitoring the creep of a turbomachine vane, in particular that of an aircraft.

### TECHNICAL BACKGROUND

The technical background comprises in particular the documents EP-A1-3176 561, EP-A1-3171 127 and DE-A1-10 2008 037412.

A turbomachine comprising a turbine 10 as shown in FIG. 1 is known.

The turbine 10 may be a low-pressure turbine arranged downstream of a combustion chamber of the turbomachine and configured to drive a fan shaft of the turbomachine by expanding the gases leaving the combustion chamber.

The turbine 10 comprises a plurality of stator vanes 12 carried by a fixed casing 14, and a plurality of rotor vanes 16 carried by rotor discs 18 which are secured to each other and rotatable about a longitudinal axis A of the turbomachine.

The rotor discs 12 are connected to a low-pressure shaft 20 which is configured to drive the fan shaft, either directly or via a reduction gear for example.

A rotor vane 16 is shown in FIG. 2 and stator vanes 12 are shown in FIG. 3.

The rotor vane 16 comprises, for example, a blade 22 extending between two platforms, respectively inner 24 and outer 26 (or radially inner and outer with reference to axis A). The outer platform 26 is called a heel, and the inner platform 24 allows the blade 22 to be connected to a root 28.

The platforms 24, 26 define between them portion of the gas flow path in the turbine 10. The roots 28 are used to mount the rotor vanes 16 on the rotor discs 18.

The heels 26 of the rotor vanes 16 have lips 30 configured to cooperate with abradable seals carried by the casing 14 facing the rotor vanes 16 to ensure sealing in the turbine 10.

The stator vanes 12 form a turbine stator which has an annular shape and is divided into sectors. Each turbine stator sector comprises two platforms, respectively inner 34 and outer 36, between which extend several vanes 12 or blades 32. FIG. 3 shows a turbine stator sector comprising three vanes 12 and therefore three blades 32.

The rotor and stator vanes 12, 16 are subject to high stresses due in part to the temperatures to which they are subjected during operation, particularly above 800° C. This “threshold” depends on the material and the load. At low loads, this threshold will be higher to detect the problem of creep over the long term in relation to engine running time.

As a result, these vanes 12, 16 may exhibit creep deformations that are important to monitor.

The creep of a part corresponds to the deformation over time of a material subjected to a constant stress and a given temperature. This deformation can lead to the fracture of the part.

The creep is characterised by three main states illustrated in FIG. 4:
(I) Primary creep: in the initial stage, the strain rate & is relatively high, but decreases with increasing time and strain as the material undergoes an increase in the creep resistance or strain hardening,
(II) Secondary creep: sometimes referred to as steady-state creep, the rate of deformation & is constant, i.e. the curve becomes almost linear. The rate of deformation becomes almost constant at the start of the secondary stage. This is due to the balance between strain-hardening and annealing (thermal softening). This creep stage is the best understood. The steady-state creep is often the longest creep phase, and
(III) Tertiary creep: this corresponds to intergranular fracture due to decohesion of the grain boundaries, which will lead to striction and the appearance of porosities in the material. It's when this condition becomes too prevalent in critical areas that the part starts to crack and eventually break. There are digital models for simulating vane creep that allow the service life of vanes to be determined theoretically. However, the estimated service life does not correspond to the actual service life of the vanes, and by extension of the turbine, due to the conservative assumptions built into the calculation approach.

The creep fractures are linked to structural phenomena, but their origin may be linked to local phenomena that are difficult to quantify directly (e.g. elongation measurements of the order of a few hundredths of a millimetre).

Today, endoscopies can be performed to verify that there are no cracks initiated by creep in the rotor and stator vanes of the turbine. However, the endoscopies do not reveal the state of the creep in the areas concerned, and in particular the appearance of the tertiary creep in a generalised manner, heralding the imminent failure of the part. As a result, it is not possible to predict the time at which the onset of creep can be expected.

So, for the parts that perish during creep, it is necessary to develop a methodology for quantifying the state of creep and estimating the real potential of the part. Since the creep is characterised by local deformation of the material, the creep potential of the part can very often be correlated with the geometric deformation of portion of the part. The challenge is to establish a stopping criterion based on the measurement of this deformation.

Today, the creep is not monitored. One possible solution would be to measure characteristic distances of the parts using cameras used in endoscopy.

However, the camera may not have enough clearance in the engine to allow accurate measurement of long distances without using “Fish Eye” technology. The latter gives a panoramic view, extending the field of vision. However, due to this technology, the images displayed are distorted, which does not allow measurements to be taken between geometric elements that are too far apart.

Another way would be to make visual indicators (felt pen marks) and measure the distance between these indicators and the tips of the blades. However, over time, corrosion, oxidation, dirt and pollution are likely to erase the visual indicator, reducing the accuracy of the measurement.

The aim of the present invention is to provide a simple, effective and economical solution to this problem.

### SUMMARY OF THE INVENTION

The invention relates to a method for monitoring a turbomachine vane, in particular of an aircraft, the vane being made of a metal alloy and comprising at least one platform connected to at least one blade, the method comprising the following steps:
a) determining at least one geometric parameter for monitoring the vane, this parameter having a value which changes as a function of the deformations by creep of the vane,
b) determining an acceptability threshold for the or each parameter,
c) verifying in particular in situ the conformity of the or each parameter with respect to the corresponding threshold, preferably by mounting at least one verifying template directly on the vane, this template having a shape complementary to a portion of the vane comprising the parameter to be verified, and by detecting the possible presence of clearance(s) between the template and this portion of the vane on which the template is positioned, and
d) concluding on the conformity of the vane as a function of the results of the verification.

The invention enables the creep level of a vane to be monitored simply and reliably. To do this, a compliance threshold is predetermined for one or more geometric parameters, and the vane is verified against these thresholds to verify whether or not it is compliant. The value of the or each parameter is preferably likely to change significantly and can be easily quantified.

In this case, the inspection or verification is carried out in situ. This means that it is carried out directly on the vane and not at a distance from it, using a laser.

A compliant vane can continue to be used in a turbine. On the contrary, a non-compliant vane will have to be scrapped and replaced by a new one in the turbine.

The method according to the invention can be carried out on a dismantled vane, but also on a vane mounted in a turbine module or sub-module. All you need is access to the vane within this module or sub-module to carry out the verification.

The method according to the invention may also have one or more of the following characteristics, taken alone or in combination with each other:
the template is preferably rigid or non-deformable,
step a) consists of determining a single geometric monitoring parameter;
the platform comprises a spoiler on the side of a leading or trailing edge of the blade, the parameter or one of the parameters determined in step a) being an angle formed by this spoiler, in particular with respect to a reference frame;
said angle is measured with respect to a plane wherein the rest of the platform mainly extends;
the parameter or one of the parameters determined in step a) is a curvature of the blade;
the parameter or one of the parameters determined in step a) is a profile of a leading or trailing edge of the blade;
step c) comprises the sub-steps of:
i) measuring a value of the or each parameter directly on the vane, and
ii) comparing the or each measured value with the corresponding threshold;
step c) comprises the sub-steps of:
j) mounting at least one monitoring template directly on the vane, this template having a shape complementary to a portion of the vane comprising the parameter to be monitored, and
jj) monitoring the positioning of the template on the portion of the vane and detecting the possible presence of a clearance or clearances between the template and this portion;
the template is mounted on the platform, on a spoiler of the platform, or on a leading or trailing edge of the or each blade;
the vane is part of a turbine module or sub-module;
step a) comprises a sub-step consisting of producing at least one chart from several vane samples;
the chart or each chart shows the evolution of the value of a monitoring parameter as a function of the number of cycles of the turbomachine or turbine comprising the part;
the vane is a rotor or stator vane;
the vane is formed in a single part; alternatively, it is formed by assembling parts ;
said platform is an external platform, or alternatively an internal platform;
the vane comprises a single platform;
the vane comprises two platforms, an inner platform and an outer platform, between which the blade or blades extend;
the vane comprises a single blade;
the vane comprises at least two blades.

### BRIEF DESCRIPTION OF THE FIGURES

Further characteristics and advantages of the invention will become apparent from the following detailed description, for the understanding of which reference is made to the attached drawings wherein:

FIG. 1 is a schematic half-view of an aircraft turbomachine in axial section, and in particular of a turbine of this turbomachine;

FIG. 2 is a schematic perspective view of a rotor vane of the turbomachine of FIG. 1;

FIG. 3 is a schematic perspective view of a stator vane of the turbomachine of FIG. 1;

FIG. 4 is a graph showing the change in elongation ε of a part over time t, when the part is subjected to a constant stress at a constant temperature;

FIG. 5 is a block diagram showing the steps of a method according to the invention for monitoring a vane;

FIG. 6a-6c FIGS. 6a-6c are schematic views of a spoiler of a vane, and show three levels of vane creep deformation respectively;

FIG. 7 is a schematic view of a spoiler of a vane, and shows the geometric monitoring parameters of this vane;

FIG. 8a-8c FIGS. 8a-8c are schematic views of a spoiler of a vane and a monitoring template mounted on this spoiler, and respectively represent three distinct positions of the template related to the creep of the vane;

FIG. 9 is a graph showing the evolution of the parameter illustrated in FIG. 7 as a function of the number of operating cycles of the turbomachine or turbine;

FIG. 10 is a schematic cross-sectional view of a vane and shows a geometric monitoring parameter for this vane; and

FIG. 11 is a schematic view of a vane and shows another geometric parameter for monitoring this vane.

### DETAILED DESCRIPTION OF THE INVENTION

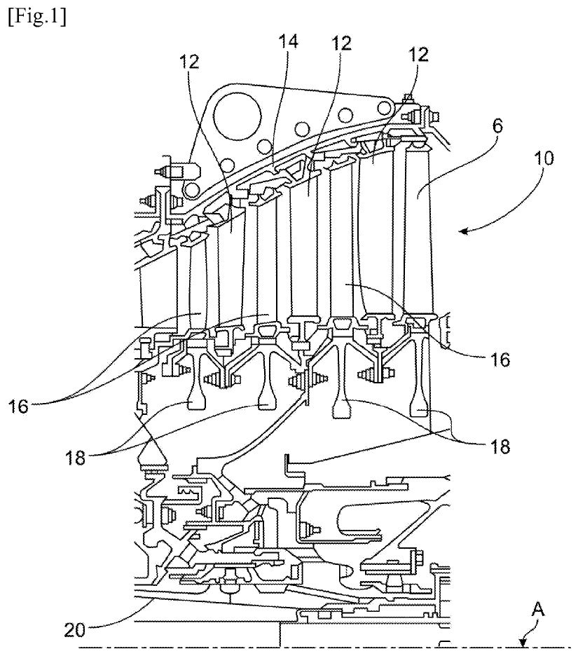

FIGS. 1 to 4 have been described above.

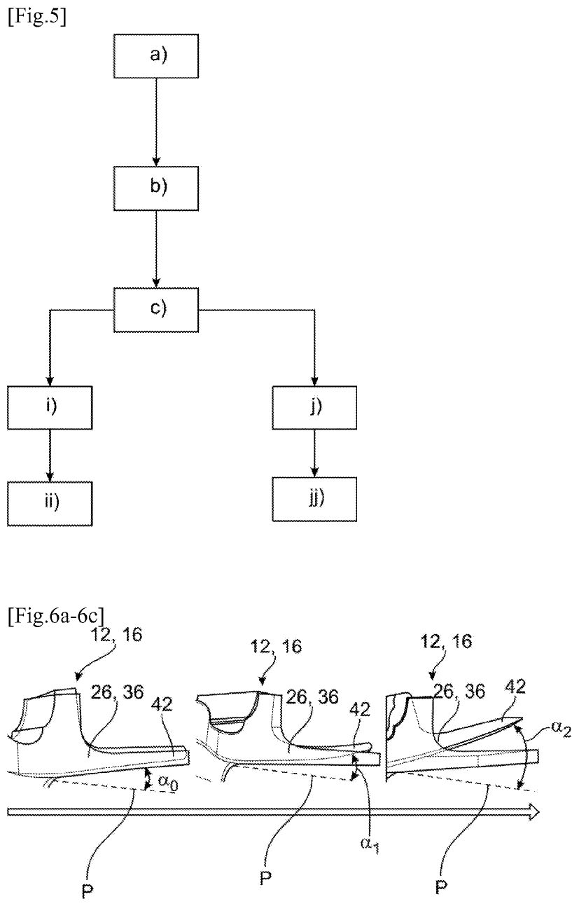

Reference is now made to FIG. 5, which illustrates an embodiment according to the invention for monitoring the creep of a turbomachine vane, in particular that of an aircraft.

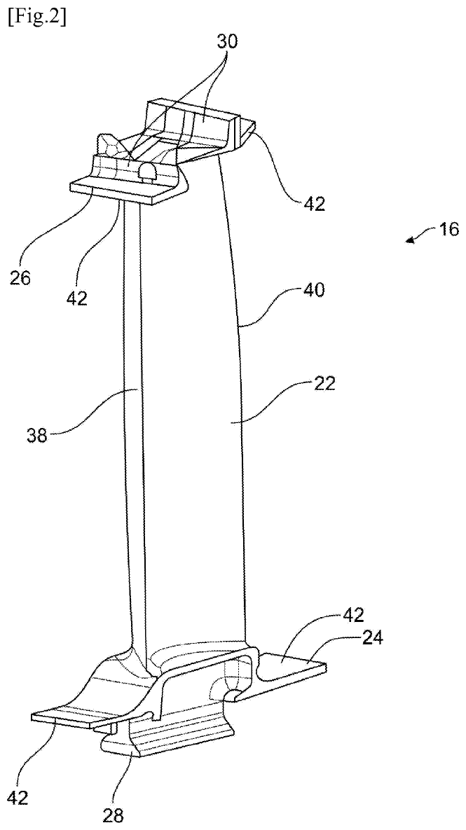

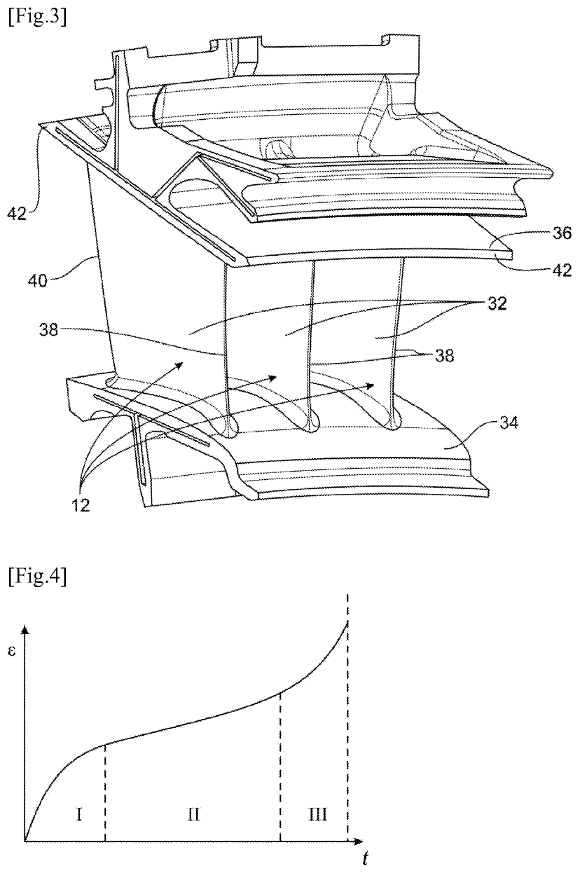

This vane may be a rotor 16 or a stator 12 vane as shown in FIGS. 2 and 3.

The vane is made of metal alloy. It can be formed from a single part or, alternatively, be made by assembling parts. The vane comprises at least one platform connected to at least one blade. In the example shown, the vane comprises two platforms, an inner one 24, 34 and an outer one 26, 36, between which at least one blade 22, 32 extends.

During operation, the gases flowing through the vanes and blades reach high temperatures that can cause creep.

The method according to the invention comprises the steps of:
a) determining at least one geometric parameter for monitoring the vane, this parameter having a value which is likely to change, preferably significantly and easily quantifiable, as a function of the deformations by creep of the vane,
b) determining an acceptability threshold for the or each parameter,
c) verifying in situ that the or each parameter complies with the corresponding threshold, and
d) concluding that the vane is compliant based on the results of the verification.

The method according to the invention therefore essentially comprises 4 steps a), b), c) and d). Each of these steps may comprise sub-steps. The first step a) consists of determining one or more geometric monitoring parameters for the vane. The monitoring parameter may be unique in that a single parameter may be sufficient to monitor the creep of the vane, for example in the area most susceptible to deform by creep during operation.

As we will see below, this parameter can be a distance or an angle, for example.

The step a) may comprise a sub-step consisting in producing a chart from several vane samples, this chart showing, for example, the evolution of the value of a monitoring parameter as a function of the number of cycles undergone by this part. A cycle is understood as an operating cycle of the turbomachine or turbine, and includes, for the aircraft, start-up, take-off, cruise flight, landing and engine shutdown.

The second step is to determine the threshold of acceptability for the or each monitoring parameter. For example, for an angle, a threshold could be determined so that, when the value of this angle is less than the threshold, the creep of the vane is not significant, and when the value of this angle is greater than the threshold, the creep of the vane is too great and the vane risks cracking or breaking. In another example, for a distance, a threshold could be determined so that, when the value of this distance is greater than the threshold, the creep of the vane is not significant, and when the value of this distance is less than the threshold, the creep of the vane is too great and this vane risks cracking or breaking. The step c) consists of verifying that the or each parameter complies with the corresponding threshold, directly on the vane. We will see that there are at least two approaches to this step c).

This step c) can be carried out on a dismantled vane or turbine stator sector, or on a vane mounted in a turbine module or sub-module;

Finally, the step d) concludes whether the vane is compliant, and therefore its creep level, based on the results of step c).

FIGS. 6a to 9 illustrate a first geometric parameter that can be monitored as part of the method according to the invention, and which relates to a platform spoiler.

Each of the platforms 24, 26 comprises an upstream edge located on the side of a leading edge 38 of the blade 22, 32, and a downstream edge located on the side of a trailing edge 40 of the blade 22, 32 (FIGS. 2 and 3). Each of these upstream and downstream edges forms a spoiler 42.

As can be seen in the drawings, this spoiler 42 is cantilevered and is a preferred zone for creep deformation of the vane 12, 16.

The centrifugal forces, gas forces and even the pre-twist mounting of the vanes have an even greater influence on the segments of the part that are cantilevered, which can generate local stress concentrations. For example, the upstream spoiler of the heel is cantilevered and generates a local concentration of stresses at the upper leading edge of the blade under the effect of centrifugal force. These local stresses can lead to cracking in the critical zone or even creep failure at the top of the blade from the leading edge to the trailing edge, along the heel. This geometric deformation due to creep is observed in the upstream spoiler of the heel, which shows an upward deflection. Once correlated with the state of creep in the blade, it is the measurement of the deflection of the spoiler that allows to establish a monitoring parameter for the part.

FIGS. 6a to 6c show, for example, three distinct levels of creep of the spoiler 42 of an outer platform 26, 36 of a vane 12, 16. In FIG. 6a, the spoiler 42 has not undergone any creep. In FIG. 6b, the spoiler 42 has begun to deform by creep by deforming outwards, i.e. away from the blade 22. In FIG. 6c, this deformation is even greater and the vane risks cracking or even breaking. FIGS. 6a-6c show that the angle a formed by the spoiler 42 with the rest of the platform 26, 36, and in particular with a plane P passing through the rest of the platform 26, 36, varies and in particular increases with the creep.

The angle α can therefore be a monitoring parameter within the meaning of the invention.

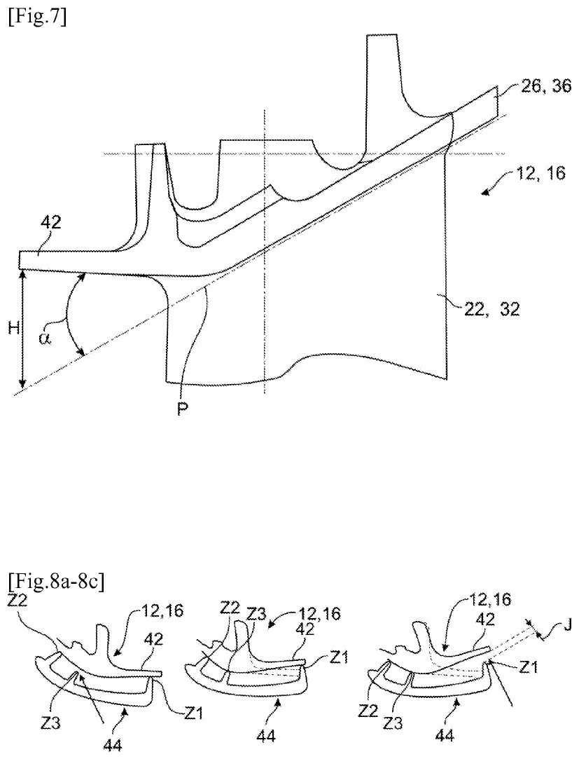

Instead of angle α, a distance H between plane P and the end of the spoiler 42 could be used as a monitoring parameter (FIG. 7).

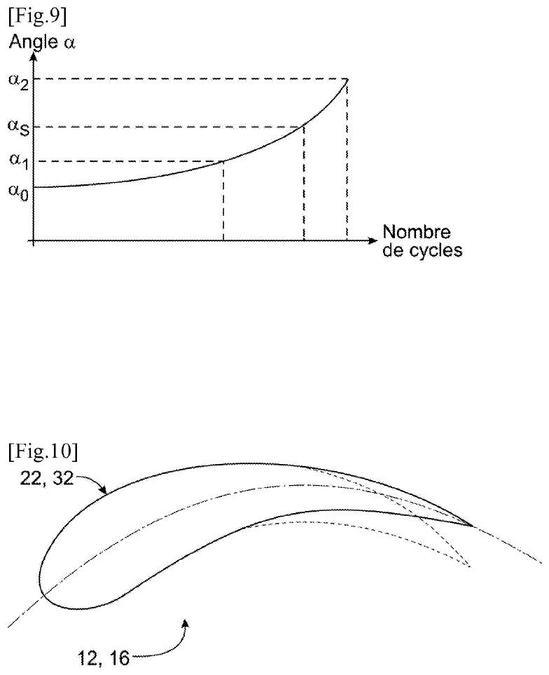

FIG. 9 shows the change in the angle a of the spoiler 42 as a function of the number of turbomachine cycles. This figure is a chart as described above. The initial angle of the spoiler shown in FIG. 6a is α0. The compliance threshold for this angle is noted αs. If the angle α1 of the spoiler is less than the threshold αs, the vane can continue to be used because the creep of the vane is not yet too great. If the angle α2 of the spoiler is greater than the threshold αs, the vane must be scrapped and replaced, as it is liable to crack at any time.

According to one embodiment of the invention (FIG. 4), step c) comprises the sub-steps of:
i) measuring a value of the or each parameter, such as angle a or distance H, directly on the vane, and
ii) comparing the or each value measured with the corresponding threshold.

The measurement sub-step i) can be performed using any suitable tool, such as a protractor, comparator, ruler, gauge, etc. The comparison sub-step can be performed by a computer or simply by the operator performing the value measurement. This operator will have no difficulty determining whether the value measured in sub-step i) is below or above the threshold value.

According to an alternative embodiment of the invention, step c) comprises the sub-steps of:
j) mounting at least one monitoring template 44 directly on the vane, this template having a shape complementary to a portion of the vane comprising the parameter to be monitored, and
jj) monitoring the positioning of the template 44 on the portion of the vane and detecting the presence of any clearance(s) J between the template and this portion. This variant is illustrated in FIGS. 8a to 8c.

The chosen template 44 has a complementary shape to the platform and spoiler 42, for example when the parameter to be monitored is at the threshold value. The template 44 defines support points on the platform in predetermined zones, for example a first zone Z1 at the spoiler 42, a second zone Z2 at the rest of the platform, and a third zone at the junction of zones Z1 and Z2. The template 44 is designed to be inserted under the platform 26, 36, where it meets the blade 22, 32. In the case of a rotor vane 16 (FIG. 2), the template 44 can be engaged on either side of the leading edge 38 or trailing edge 40, or on both sides. In the case of a stator vane 12 or a turbine stator (FIG. 3), the template 44 may be engaged over portion only or over the entire circumferential extent of the turbine stator and may therefore extend in front of the leading edges 38 of several blades 32 or behind the trailing edges 40 of several blades 40.

In FIG. 8a, the spoiler 42 is similar to that in FIG. 6a. The template 44 is supported in zones Z1 and Z2 and is deliberately not supported in zone Z3.

In FIG. 8b, the spoiler 42 is similar to that in FIG. 6b. The template 44 is supported in all zones Z1, Z2 and Z3.

In FIG. 8c, the spoiler 42 is similar to that in FIG. 6c. The template 44 is supported at zones Z2, Z3 and a gap J appears at zone Z1, this gap J being visible to an operator. The existence of this set is detected at sub-step jj) and allows an operator to declare the vane as non-conforming

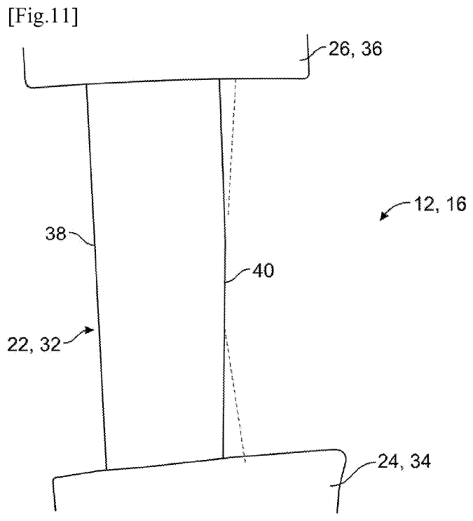

Alternatively, the parameter that could be monitored in step c) could be:
the curvature of the blade 22, 32, which is likely to change locally as the creep of the vane (FIG. 10),
the profile of the leading edge 38 or trailing edge 40 of the blade 22, 32 (FIG. 11).

Depending on the monitoring parameter(s) selected, one or more templates are mounted on one of the platforms, on one of the spoilers, on the leading or trailing edge of the blade or one of the blades, etc.

This invention enables vanes to be scrapped as late as possible, while ensuring that turbines and turbomachines operate smoothly. It thus allows significant financial savings because there are fewer parts to replace as their use is maximized, fewer anticipated turbine removals impacting the customer, fewer parts to replace because the risk of part breakage and debris release is significantly reduced, etc. In conclusion, this invention improves the robustness of turbomachines and turbines and reduces the risk of unplanned engine removals.

1. A method for monitoring the creep of a turbomachine vane, in particular of an aircraft, the vane being made of a metal alloy and comprising at least one platform connected to at least one blade, the method comprising the following steps:
a) determining at least one geometric parameter for monitoring the vane, this parameter having a value which changes as a function of the deformations by creep of the vane,
b) determining an acceptability threshold for the or each parameter,
c) verifying in particular in situ the conformity of the or each parameter with respect to the corresponding threshold, by mounting at least one verifying template directly on the vane, this template having a shape complementary to a portion of the vane comprising the parameter to be verified, and by detecting the possible presence of a clearance(s) between the template and this portion of the vane on which the template is positioned, and
d) concluding on the conformity of the vane as a function of the results of the verification.

2. The method according to claim 1, wherein step a) consists of determining a single geometric monitoring parameter.

3. The method according to claim 1, wherein the platform comprises a spoiler on the side of a leading edge or trailing edge of the blade, the parameter or one of the parameters determined in step a) being an angle (α) formed by this spoiler.

4. The method as claimed in claim 3, wherein said angle (a) is measured relative to a plane (P) wherein the rest of the platform mainly extends.

5. The method according to claim 12 wherein the parameter or one of the parameters determined in step a) is a curvature of the blade.

6. The method according to claim 1, wherein the parameter or one of the parameters determined in step a) is a profile of a leading edge or trailing edge of the blade.

7. The method according to claim 1,
wherein the template is mounted on the platform, on a spoiler of the platform, or on a leading edge or trailing edge of the or each blade.

8. The method according to claim 1, wherein the vane is part of a turbine module or sub-module.
